(19) United States
(12) Patent Application Publication
(10) Pub. No.: US 2025/0202386 A1
(43) Pub. Date: Jun. 19, 2025

(54) Continuous Electric Power System

(71) Applicant: Cosmogenic Motors LLC, Delray Beach, FL (US)

(72) Inventor: Julian A. Fano, Delray Beach, FL (US)

(21) Appl. No.: 18/537,799

(22) Filed: Dec. 13, 2023

(51) Int. Cl. H02P 5/00; H02J 3/38; H02P 1/54; H02P 9/02

(52) U.S. Cl. CPC H02P 5/00; H02J 3/38; H02P 1/54; H02P 9/02

(57) ABSTRACT

A power system that is for any vehicle (land, sea or air) and or any device/item/thing that consumes electricity. This may also be used as a method to produce electricity to be sold. It may also be used as a system to charge a large battery or, 2 or more batteries. The power system would be scaled to the appropriate size depending on application. The design is configured in such a way that the electricity produced is enough to power any electric motor or motors of any voltage and/or amperage or power anything that consumes electricity. The design is also configured in such a way that the electricity/energy produced is continuous and does not stop until the system is switched off. The system may be wired in series, in parallel or both depending on application and energy requirements.

### BRIEF SUMMARY OF INVENTION

In view of the above, the primary objective of the invention is to provide an electric power system and management method, which could allow a user to easily produce enough electric energy to power any (land, sea or air) vehicle, device or item that consumes electric energy. This invention could also be used as a method to produce electricity to be sold. It could also be used to charge a battery or batteries.

The invention provides an electric power system, which has been configured to supply power to a load, where the electric power system includes an alternator or alternators, a motor or motors, a starter motor and a management apparatus. The alternators are adapted to supply power to the load. The alternators are modified in such a way that the voltage and amperage have no limit. There may be a limit placed for an alternator voltage and amperage depending on application. The system can be either AC or DC. Wiring from alternator to alternator can either be connected in series, parallel or both depending on application. Wiring from the alternators then would be routed to a module and electronic speed control (MSCU). From the MSCU, the wiring would go to an electric motor or motors. (This system could also be wired in the following way. The wiring from the alternators would go to the MSCU, then would be routed to an electric motor or motors. From the MSCU to the electric motor or motors it would be wired in parallel, in series or both series and parallel.) The option of having a device that steps up voltage and/or amperage in the circuit could be placed either before or after the MSCU. The starter would operate on a separate circuit. The starter motor circuit would consist of a battery (or similar device) and a starter motor. The motor spinning the alternators has a shaft that sticks out on both sides of the motor. There is a flywheel or gear on one side of the electric motor that the starter engages to. On the other side of the motor there is a pulley. Each alternator has a pulley. A belt connects the motor pulley with the alternator pulleys. At a certain motor RPM, the system produces enough power to keep the electric motor (with the alternator(s)) spinning continuously. The system produces more than enough power at an idle rpm to spin the electric motor (with an alternator or alternators) at an idle speed. A device called an MSCU (or equivalent) will tell the MSL how fast to spin the motor. Once the motor (with alternator(s)) speed increases, it is possible to create more electrical energy. The purpose of this system is to generate enough energy to power the system and have a surplus of continuous electric energy. The surplus energy is energy the motor or motors are not consuming. This continuous energy does not stop until the system is shut off. The only way to power off the system is to have an electronic switch which may or may not be directed by the module to turn it on or off. This switch would be located on the power wire to the electric motor that is spinning all the alternators. This switch is powered on once the system is started and switched off when it needs to be powered off. This system eliminates the need of a large battery and charging times.

### BRIEF DESCRIPTION OF THE RELATED DRAWINGS FIGURES

### Images are Generalized

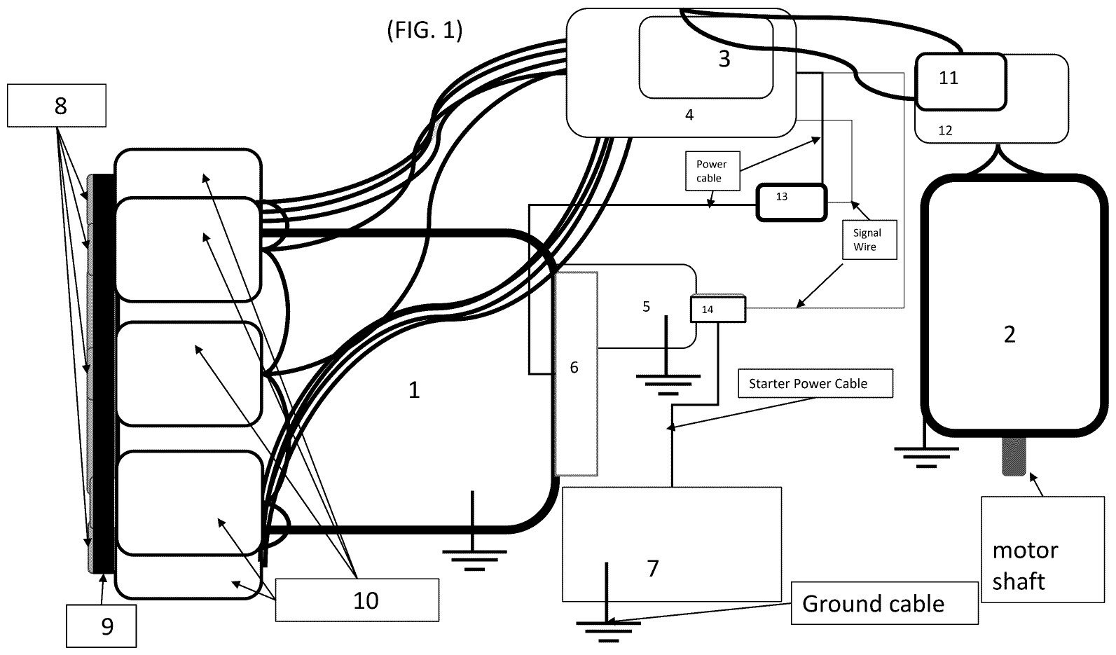

FIG. 1 Is a drawing of a 2-motor example top view of this device.

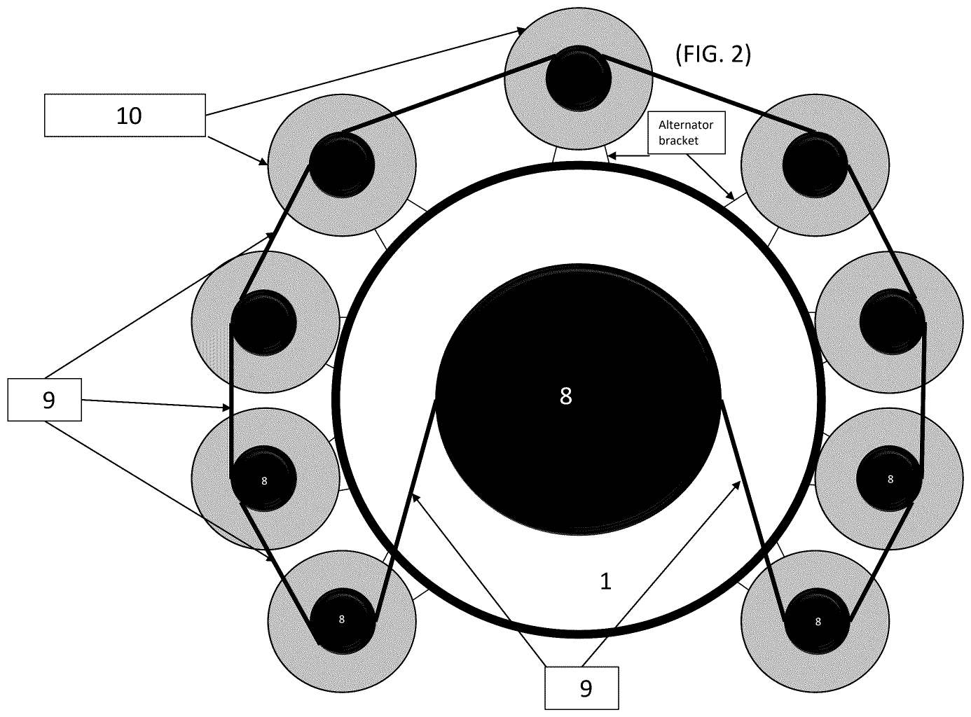

FIG. 2 Is a drawing of the front of an electric motor with alternators.

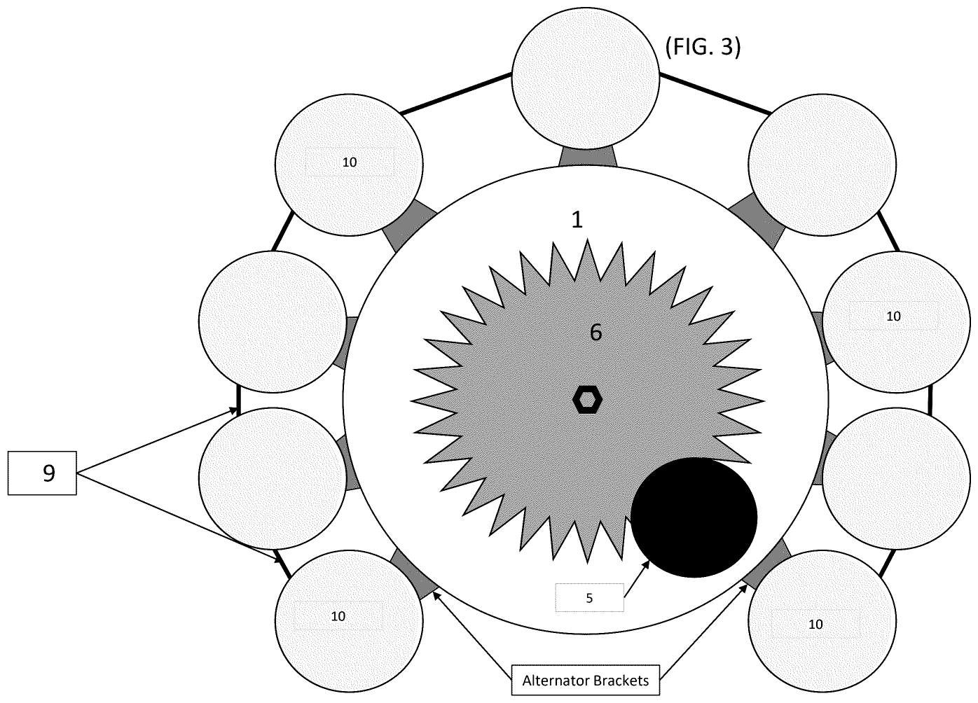

FIG. 3 Is a drawing of the rear of an electric motor with alternators.

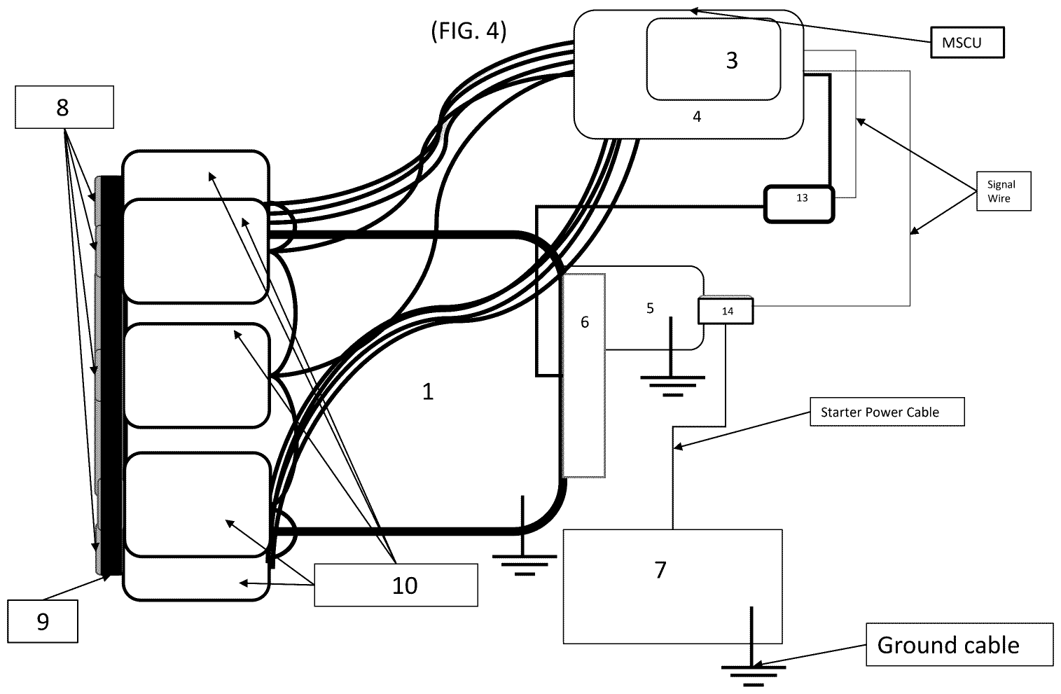

FIG. 4 Is a drawing of a 1 motor example top view of the power system.

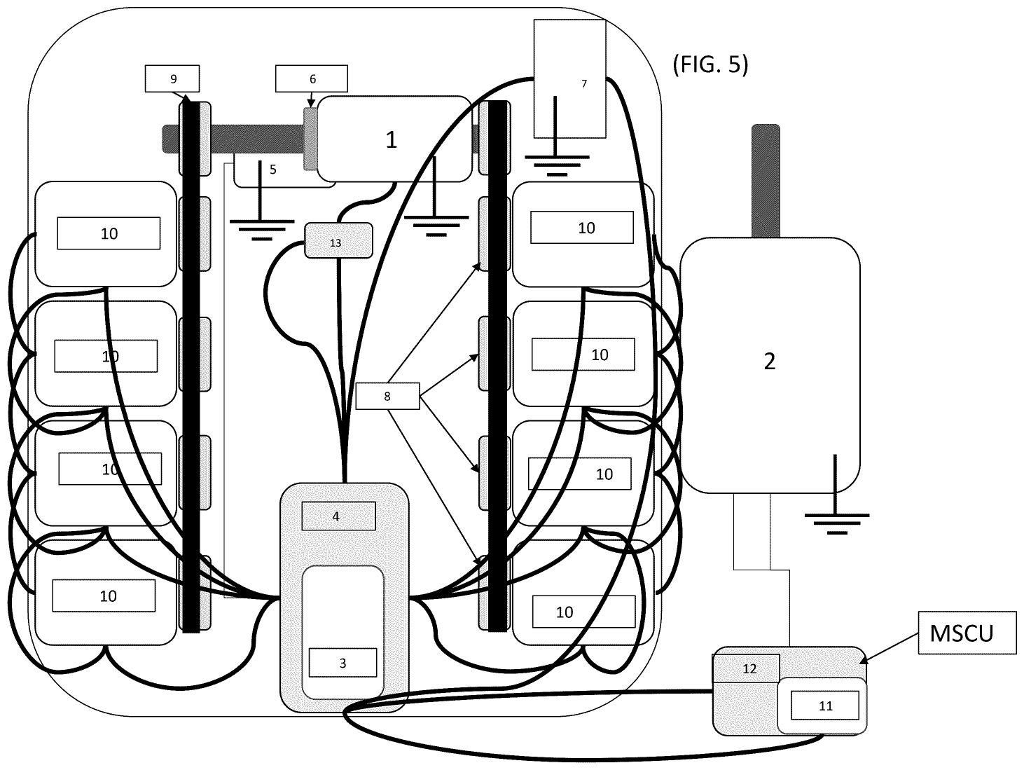

FIG. 5 Is a drawing a different design of the power system with two motors.

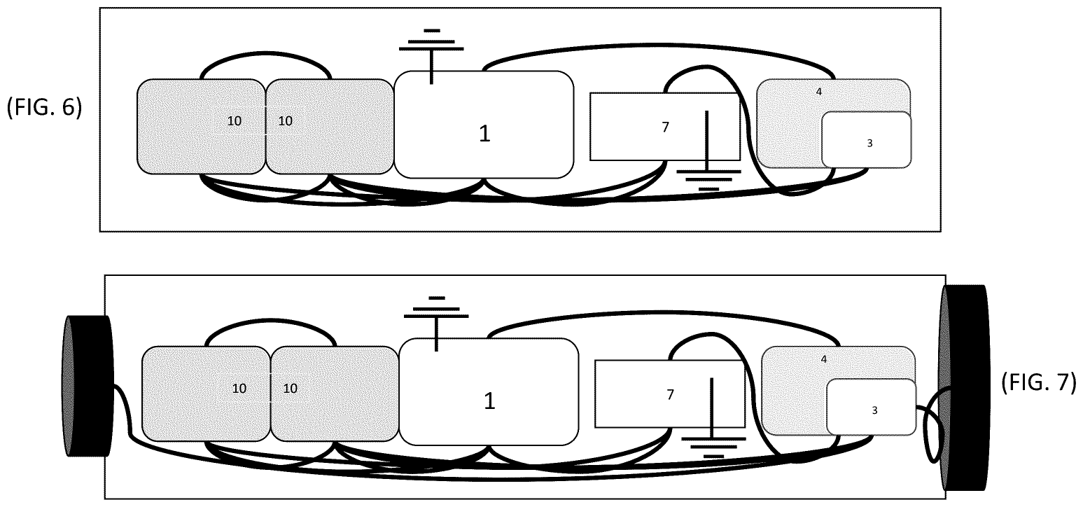

FIG. 6 Is a drawing of the top view of this device for an electronic device.

FIG. 7 Is a “AA” size battery enlarged with this power system inside.

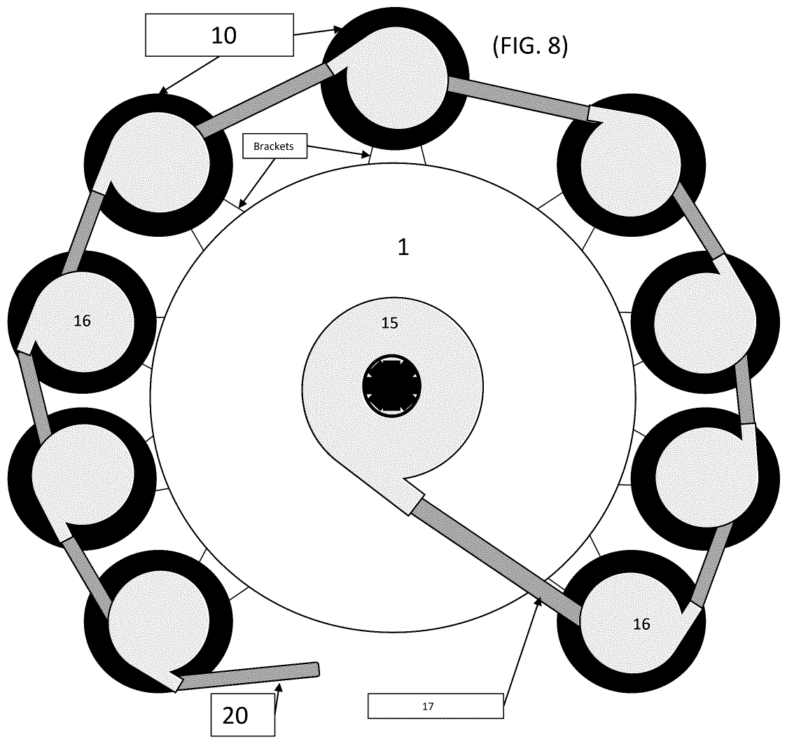

FIG. 8A drawing of the front of this power system using compressors and turbine housings and wheels.

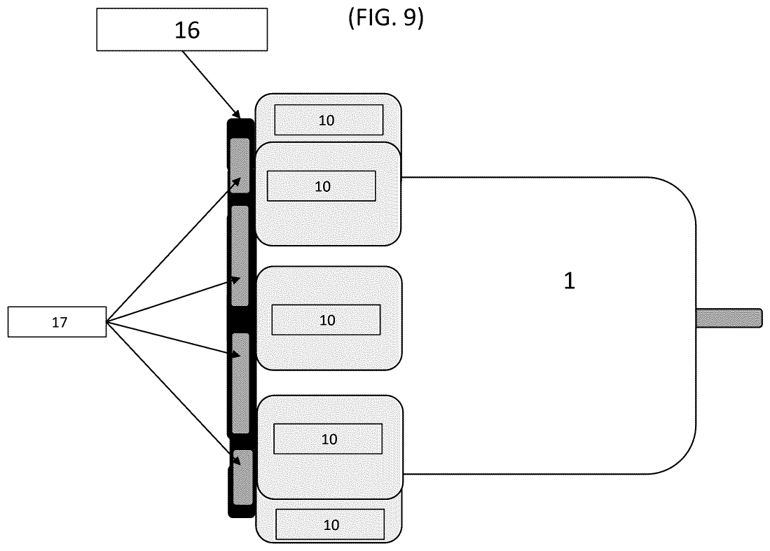

FIG. 9A drawing of the side of a power system using compressors and turbines.

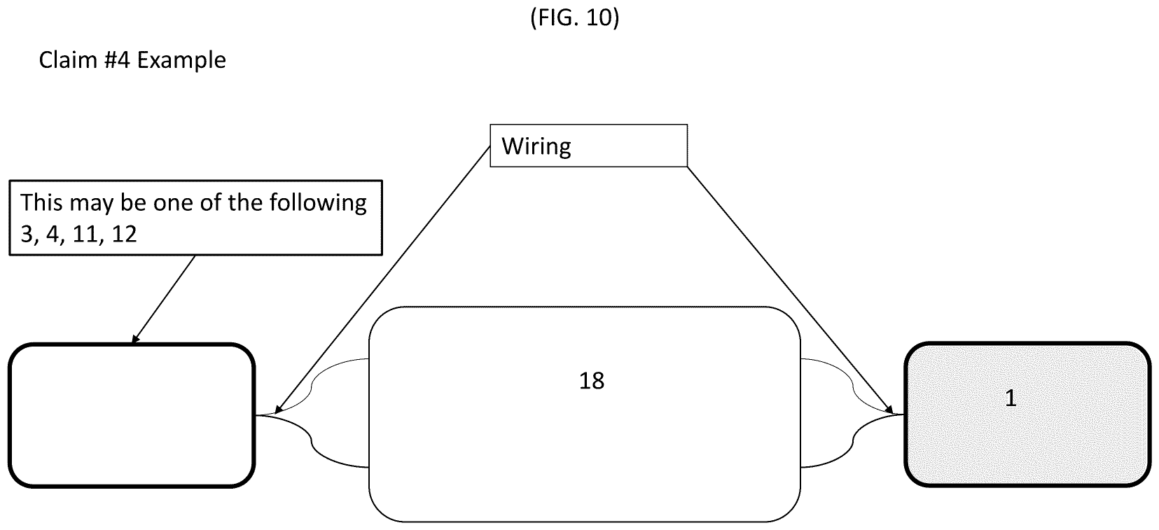

FIG. 10A drawing of a transformer/boost converter device or rectifier/inverter device for claim #4.

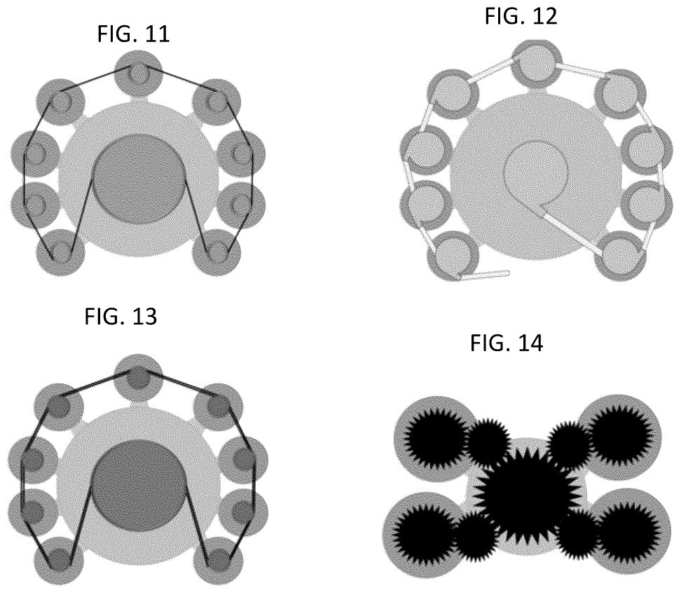

FIG. 11 Are drawings of examples for claim #5.

FIG. 12 Are drawings of examples for claim #5.

FIG. 13 Are drawings of examples for claim #5.

FIG. 14 Are drawings of examples for claim #5.

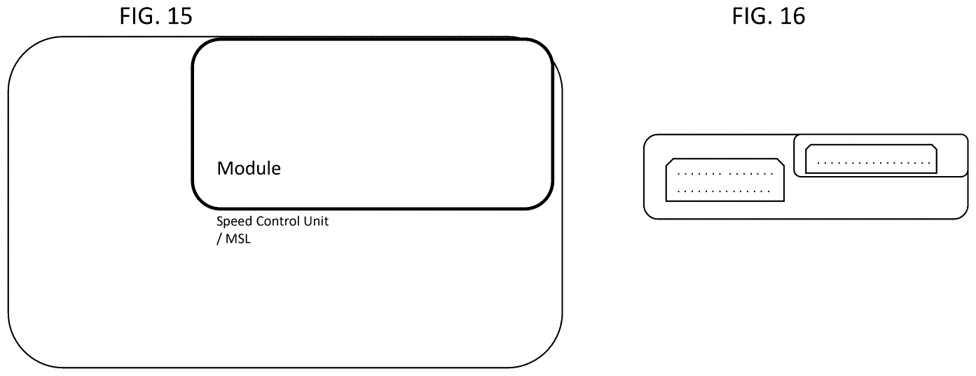

FIG. 15 Is an MSCU or a motor speed control unit. Claim #9. Top View

FIG. 16 Is an MSCU or a motor speed control unit. Claim #9. Side View

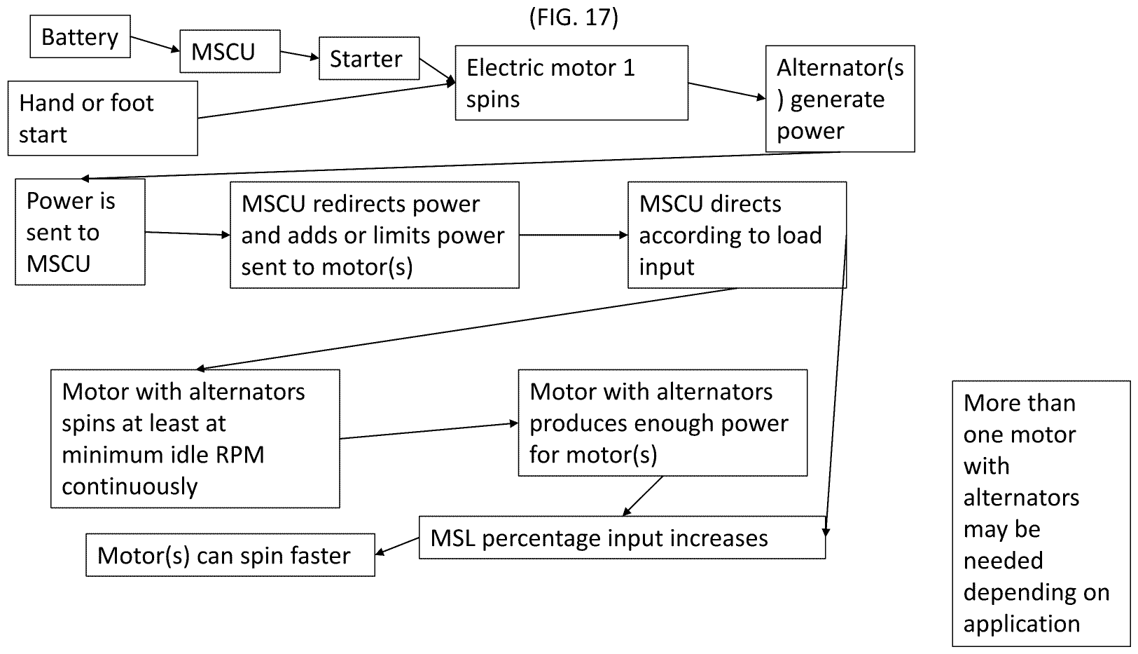

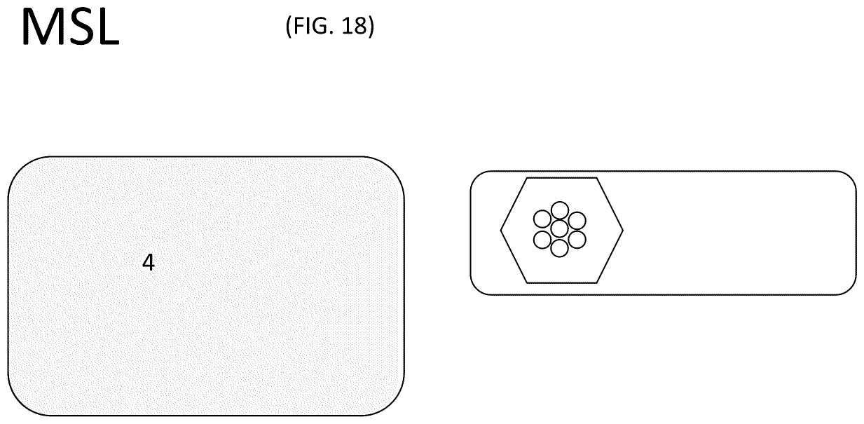

FIG. 17 Is a flow chart of how the power system is started and running.

FIG. 18 Is an MSL. Motor speed limiter. Claim #10.

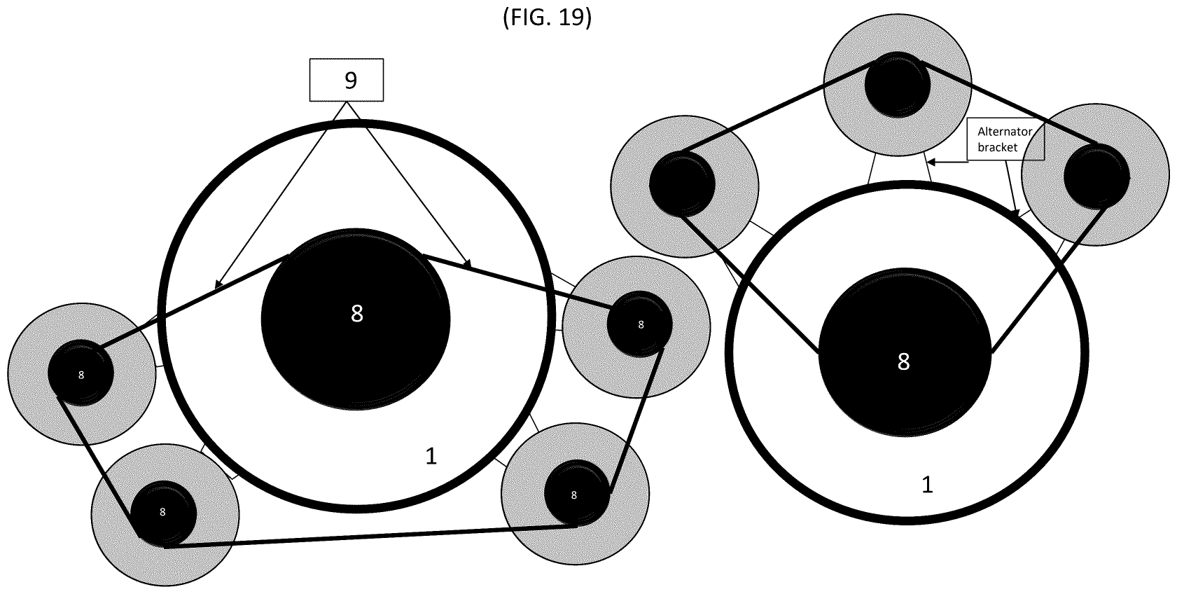

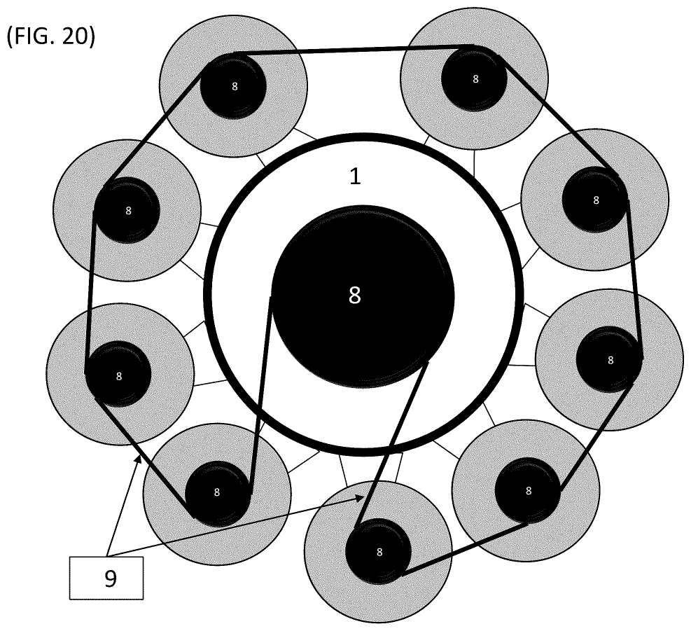

FIG. 19 Variations of how alternators may be mounted on electric motors.

FIG. 20 Is another variation of how alternators may be mounted on electric motors.

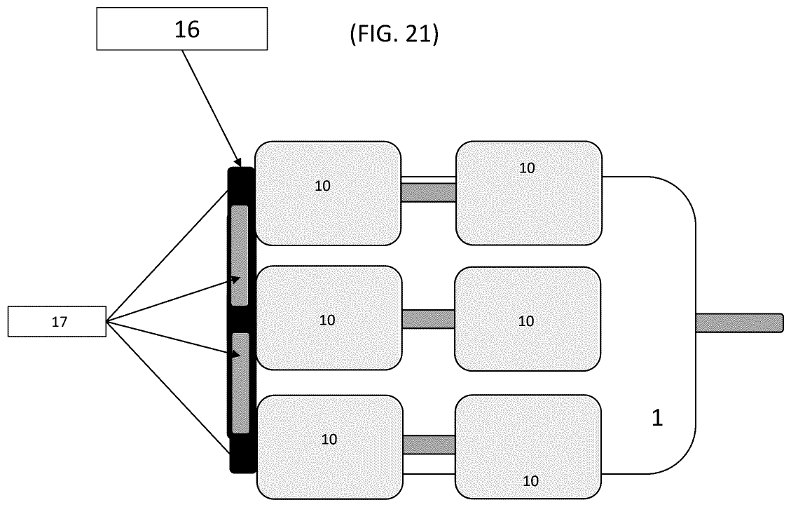

FIG. 21 An electric motor with alternators. The pairs of alternators are connected by a shaft. This is another variation of how alternators may be mounted.

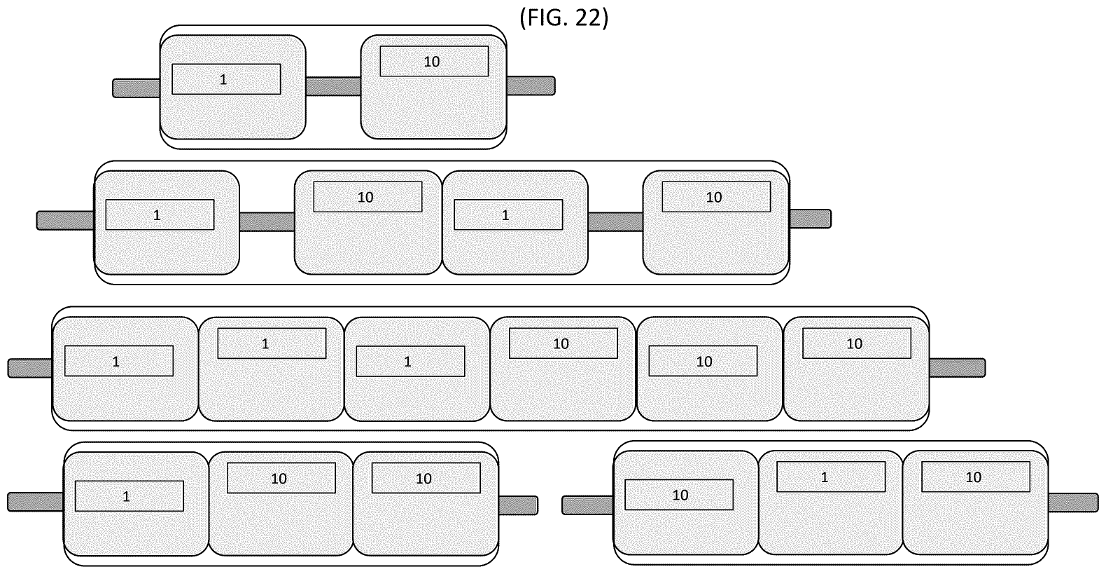

FIG. 22 Examples of Motornators (top view).

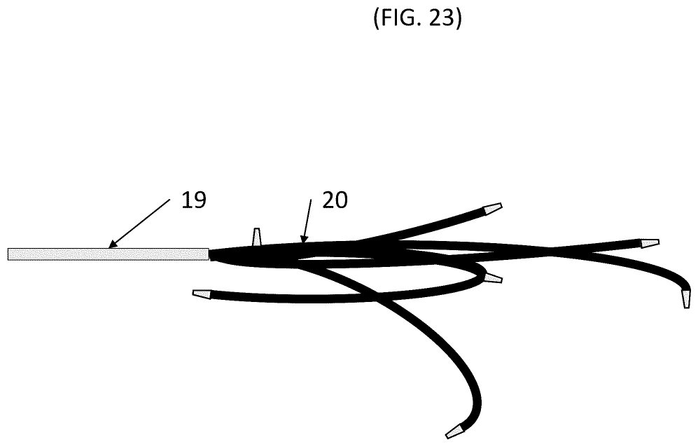

FIG. 23 Last pipe in the sequence and cooling pipes/lines with nozzles attached pointing to different areas of the power system that get hot.

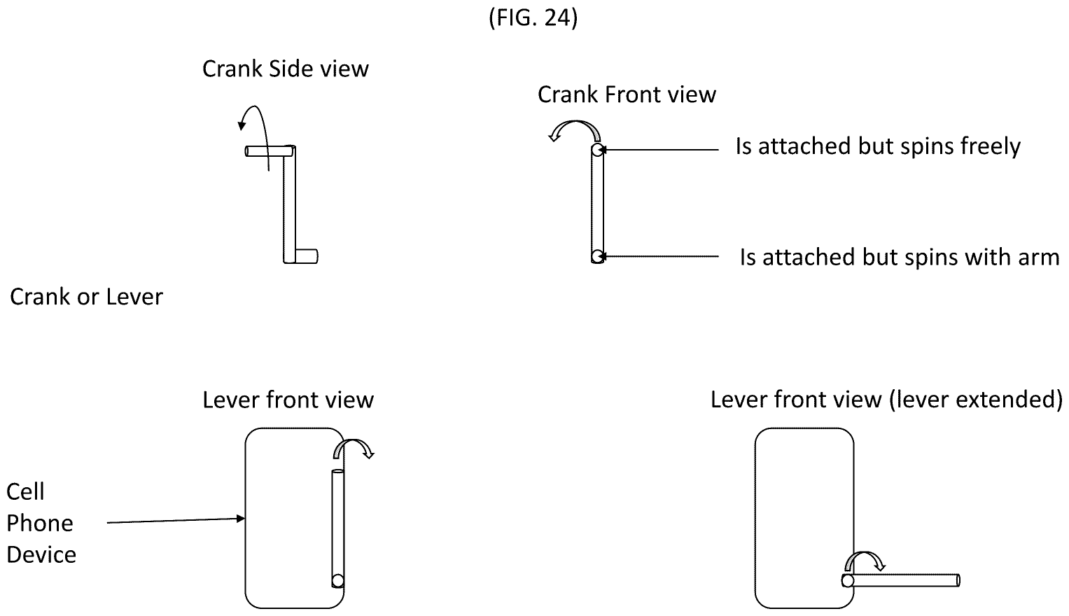

FIG. 24 Is a crank or lever example. Used when no battery/starter is present. Similar devices may be used for manual starting.

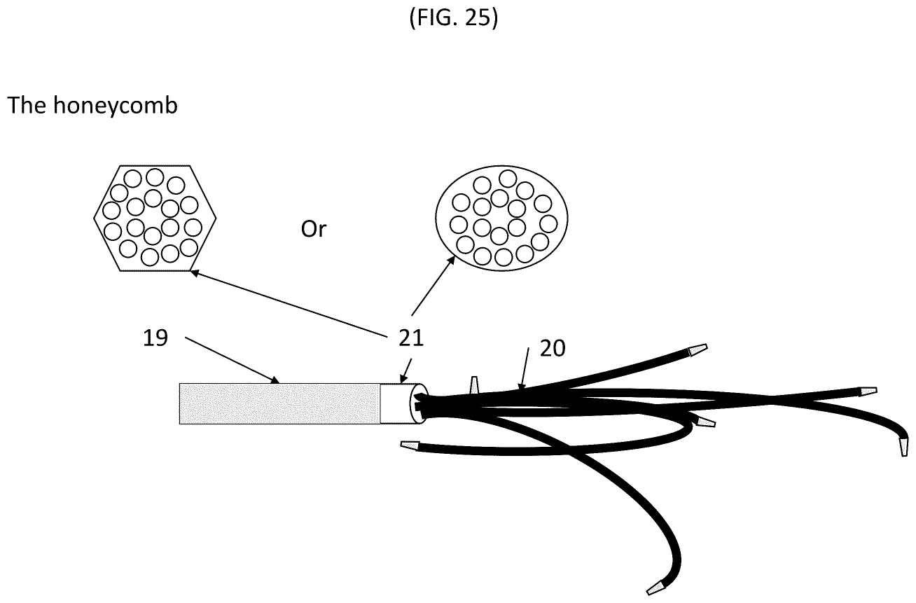

FIG. 25 The honeycomb.

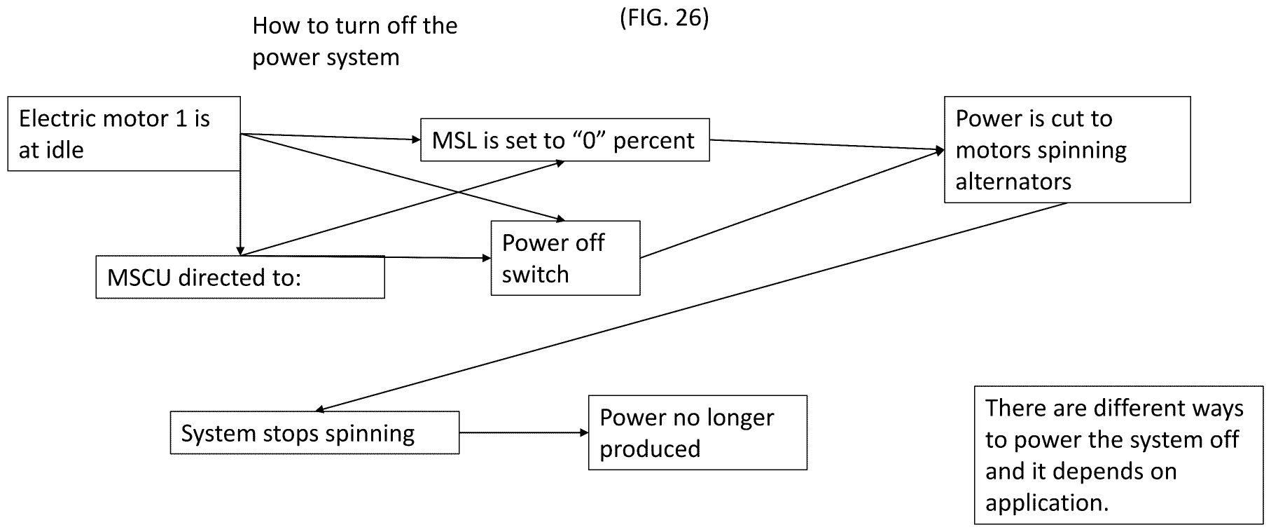

FIG. 26 Is a flow chart of how the system is turned off.

### DETAILED DESCRIPTION OF THE INVENTION

### System With 2 Motors

### (FIG. 1)

The invention provides an electric power system, which has been configured to supply power to a load, ex. an automobile, where the electric power system includes alternators (10), motors (1, 2), a starter motor (5) and a management apparatus (3,4,11,12). The alternators (10) are adapted to supply power to the load. The alternators have voltage regulation devices that allow to maximize the voltage and amperage output of an alternator. The load in this example would be an electric motor 1 and 2. Each electric motor would have a module (3, 11) and electronic speed control device (4, 12). A key or similar device would be used as a signaling device to start the system. A manual or electronically controlled device (such as a key and ignition set) sets the switch (13) to “on” on the power wire to electric motor (1), to the on position. It also sets switch (14) to on until sufficient power is made from the alternators (10) to keep motor (1) spinning at idle rpm. The battery (7) then supplies power to the starter switch (14). Switch (13) signals when starter switch (14) will be on until motor (1) has generated enough power to stay on. The starter (5) engages the flywheel (6) and then begins to spin the flywheel (6). On the motors shaft, both sides have splines where the flywheel and pulley attach. The flywheel (6) is attached on one side of the electric motor (1). Once motor (1) is spinning and making enough power, switch (14) is then set to “off.” On the other side of electric motor (1) is a pulley (8) with grooves that fit a belt (9). The belts (9) are tightened by a belt tensioner. The belt (9) is wrapped around 8 total alternators (10) with pulleys (8). One alternator (10) charges a battery (7) and supplies power to the starter (5) on a separate circuit. The 7 alternators (10) are wired in series and parallel. The wiring goes to the first set of modules (3) and electronic speed controls (4) which control motor (1). Power wires are then routed to a second set of modules (11) and speed controls (12) which power motor (2).

Motor (2) would be connected to a transmission and differential that spin both wheels on a single axle. Motor (2)'s shaft would be the side that connects to a transmission and or similar device. Motor (2) has a module (11) and electronic speed control (12) devices that communicate with motor (1) modules (3) and devices (4). Depending on how much electric energy motor (2) needs, motor (1) may increase rpm or decrease rpm to supply continuous electric power to feed motor (2). Electric power in this system will always be continuous. To switch off the system, you would simply switch to the off position on power switch (13) and that will cut power to electric motor (1).

The system would then power off.

### System With One Motor

### (FIG. 2, 3, 4)

The load in this example would be an electric motor (1). The electric motor (1) would have a module (3) and electronic speed control device (4). A key would be used in an ignition to start the vehicle. The key sets the switch (13) to “on.” The switch (13) is on the power wire to electric motor (1). Switch (14) stays on until the system is spinning at idle. The battery (7) then supplies power to the starter (5). The starter (5) engages the flywheel (6) and then begins to spin the flywheel (6). The system spins until it is at idle. The flywheel (6) is attached on one side of the electric motor (1). On the other side of electric motor (1) is a pulley (8) with grooves that fit a belt (9). The belt (9) is tightened by a belt tensioner. The belt (9) is wrapped around alternators (10). Alternators (10) are of high voltage and amperage. One alternator (10) charges the battery (7) and supplies power to the starter (5) on a separate circuit. The alternators are wired in series and/or parallel. The wiring goes to the module (3) and electronic speed control (4) which control motor (1). Power wires are then routed to motor (1). Motor (1) at idle generates more than enough electric energy to power the motor spinning at low RPM. The additional power would be used to spin motor 1 faster if needed. Electric power in this system will always be continuous. To switch off the system you would simply turn the key to the off position and that will signal the switch (13) on the power wire to electric motor (1) to the off position. The system would then power off.

### Same System But Different Design

### (FIG. 5)

The invention provides an electric power system, which has been configured to supply power to a load, where the electric power system includes alternators, motors, a starter motor and a management apparatus. The alternators are adapted to supply power to the load. The alternators have voltage regulation devices that allow to maximize the voltage and amperage output of an alternator. The load in this example would be any component that consumes electricity in order to operate. The electric motors (1) (2) would have a module (3) (11) and electronic speed control devices (4) (12). A signal would set the switch (13) to “on” on the power wire to electric motor (1) to the on position. The module (3) would briefly supply power to the starter (5). The starter engages the flywheel and then begins to spin the flywheel. Once the motor (1) reaches idle speed the module (3) would then stop sending power to the starter (5). The flywheel (6) is attached on one side of the electric motor (1). On the same side of the flywheel (6) there is a shaft that connects a pulley (8) that has grooves for a belt (9) connected to the motor (1). A belt connects 4 alternators (10) on this side. On the other side of electric motor (1) is a pulley (8) with grooves that fit a belt (9). The belts (9) are tightened by a belt tensioner. The belt (9) is wrapped around another set of 4 total alternators (10). All alternators (10) are of high voltage and amperage. A percentage of energy from the entire power system is used to send recharging energy back to the battery (7). The 8 alternators (10) are wired in series and parallel. The wiring goes to the first set of modules (3) and electronic speed controls (4) which control motor (1). There is a separate set of wiring that is routed to the battery (7) from module (3) and speed control (4). Power wires are routed from module (3) and speed control (4) to module (11) and speed control (12). Power wires are then routed to motor (2). Motor (2) has a module (11) and electronic speed control (12) device that communicate with motor (1) modules and devices. Depending on how much electric energy motor (2) needs, motor (1) may increase rpm or decrease rpm to supply continuous electric power to feed motor (2). Electric power in this system will always be continuous and in excess. To switch off the system you would simply have module (3) send a signal to change the switch (13) on the power wire to electric motor (1) to the off position. The system would then power off.

### Similar System for a Small Device

### (FIG. 6)

The power system for a device is much smaller than for other products. In this system, the battery (7) would provide enough power to start spinning the electric motor (1). Once the motor (1) is spinning, the system would produce sufficient power to keep the motor (1) spinning without the battery (7). The alternators (10) provide enough power to charge the battery (7), keep the motor spinning and provide power to a small electronic device that does not need much voltage or amperage to operate. This system would also have a module (3) and speed control (4). A design to power a small device.

### (FIG. 7)

This system works similar to previous examples except the size would be much smaller. This design could fit into a “AAA” battery casing or a battery casing that is of another size. FIG. 7 is a design that fits into a “AA” battery casing.

### Similar System With Compressors

### (FIG. 8, 9)

In the event that even more power is needed for ex. an airplane, instead of using pulleys (8) and belts (9), a similar system could instead use compressors (15), charged air piping or lines (17) and compressed air to spin alternators at RPMs that may double, triple, quadruple or multiply the rpms of an electric motor. The compressor (15) would be attached to the electric motor (1) and piping/lines (17) would be routed from the compressor (15) to each individual turbine/(compressor wheel and housing (16)) at each alternator in such a way that air pressure will be created in the system. PSI pressure may continue to increase. The last pipe/line (19) in the sequence would have excess air flow pressure which can be routed via honeycomb (21) and cooling pipes (20) to specific parts of the system that usually get hot. The air flow system could be used as a cooling method for electrical components that get hot. Each pipe would have a nozzle that produces a jet stream aimed at a specific electrical component. Multiple electric motors with each motor having several alternators would be needed to provide the energy required for propulsion. The use of a transformer or similar device would also be used depending on energy requirements. FIG. 8 is front view. FIG. 9 is top view.

### Transformer Device Addition (If Needed)

### (FIG. 10)

Shows a transformer (18) or similar device added to the system to step up or increase the voltage and/or amperage needed for a particular application.

### Variations of Design

### (FIG. 11,12,13,14)

Shows the system with different variations of how the motor can spin the alternators. FIG. 11 uses a pulley and belt system. FIG. 12 uses a compressor system with compressor wheels and housings. FIG. 13 uses sprockets and a chain. FIG. 14 uses gears. Note for FIG. 12: depending on application, compressors may also be turbines or pumps.

### MSCU or Motor Speed Control Unit

### (FIG. 15,16)

Shows a Motor Speed Control Unit (3). MSCU (3). The MSCU (3) controls the voltage supplied to the electric motor(s). It monitors voltage output from alternators, monitors total voltage produced, sets idle speed, sets RPM range, allows Addition or limits voltage and amperage sent to each electric motor, monitors temp in certain areas of system, and has other functions. In order for the system to operate correctly, the power produced by the alternators (10) at any given RPM must be greater than the power being consumed. Excess power will always be generated. This is so the motor or motors have enough power to accelerate at any given RPM. This unit operates with another device that requests a certain load. The device that requests the certain load varies depending on application. The device that requests a certain load may also be built in the MSCU (3) or equivalent device.

There are two versions of an MSCU. One that is the MAIN MSCU and the other is an MSCU. The main MSCU has a hard drive with software installed specific to its application. Software varies and would be written depending on application and if the power system uses a battery or not, how many motors and alternators there are, how many MSCU's there are, what kind of sensors are in the power system, idle and other items that are dependent on

### What the System is Being Used for. FIG. 15: Top View, FIG. 16: Side View

### (FIG. 17)

Shows an example flow chart of a large power system and how it turns on. Some operations require the MSCU. The MSCU may use battery power prior to power system starting. Software would be written based on this flow chart but specific for each application.

### MSL or Motor Speed Limiter

### (FIG. 18)

The MSL (4) is a device that requests a load in this power system. The MSL (4) can have a single preset or have the option to have many different load options depending on power requirements. Load options also depend on application. Top view and side view example shown.

### (FIGS. 19 and 20)

Shows motors with variations of alternators. 3, 4. Note: There can be any number of alternators. They also can be positioned in any way.

### (FIG. 21)

Alternators behind one another connected by a shaft that would spin both alternators simultaneously.

### The MotorNator

### (FIG. 22)

Motor and alternator single unit. Instead of having a motor and alternator as separate units, this unit would be a motor combined with an alternator under one casing. This MotorNator would be a single unit and can take the place of motor 1. The purpose of this would be to simply add more electrical energy to the power system circuit. Note: wiring not illustrated.

Motornator examples. A plate or separator may separate each alternator and electric motor. It all depends on what application the power system may be used for. Motornator's come in various sizes and are customized depending on application.

### (FIG. 23)

Last pipe (19) in the compressor system, attached to cooling pipes/lines (20). The last pipe (19) and cooling pipes/hoses (20) come in all sizes and is specific to each application.

### (FIG. 24)

If a power system does not have a battery and starter to start the system, a crank or lever may be used. A crank has one side of the arm with an attachment that spins freely. The side that does not spin freely has a gear attached. This gear spins other gears that are attached to the electric motor shaft. The gear set used here may use 2 gears or more. This mechanism would spin the motor fast enough to start the system. See illustration for example of crank.

The lever can be used on a device that is smaller in size. To start the power system, you would simply pull down on the lever. One end of the lever would have a gear set, while another gear would be attached to the electric motor. Pulling down the lever would spin the electric motor fast enough to start the system.

A push start or kick start can also be used. Similar devices may be used for manual starting.

### (FIG. 25)

The honeycomb (21) is a device that goes between the last pipe (19) and lines (20). The device would have ports that allow air to pass through. On the exit side, would be fittings or nipples that the lines would attach to. The ports on this device may be threaded so that lines may be attached. This device would be used to attach the last pipe in the sequence to multiple lines, pipes or hoses. They can come in different shapes depending on application. (hexagonal and circular pictured)

### (FIG. 26)

Is a flow chart of how the power system turns off.

NOTE: It must be pointed out that the embodiments described above are only some preferred embodiments of the present power system. All equivalent structures and methods which employ the concepts disclosed in this specification and the appended claims should fall within the scope of the present power system.

### APPENDIX

### Components

1. Motor 1
2. Motor, additional motor
3. MSCU Module
4. Electronic speed control/MSL
5. Starter
6. Flywheel
7. Battery
8. Pulley
9. Belt
10. Alternator
11. 2nd module or MSCU
12. 2nd Speed Control or MSL
13. Main power switch
14. Starter switch
15. Compressors
16. Compressor wheels and housing
17. Piping/lines/hoses/similar (compressed air)
18. Transformer/boost converter/rectifier/converter/similar devices
19. Last pipe
20. Cooling pipes/lines
21. Honeycomb

What is claimed is:

1. A power system that produces a continuous amount of electricity for any device, vehicle, application or anything that needs electric energy in order to operate. It could also be for the generation of electric energy for the purpose of being sold. It may also be used as a system to charge a battery or batteries. The power system starts (turns on) with a battery that supplies sufficient power to engage and turn a starter motor, which then spins a flywheel or gear that is attached to one end of an electric motor (motor can be AC or DC). On the other side of that motor is a pulley which has a belt that is attached to at least 1 or more alternators. This system uses at minimum 1 alternator. The alternator or alternators supply power to the battery for the starter and also supply power to the main electric motor. The system may be wired in series, parallel, other ways or use any combination of these depending on application and/or energy requirements. The power is routed to a module (MSCU) and electronic speed control device (MSL). The module will regulate voltage and dictate what rpm the electric motor should spin, in order to supply sufficient voltage/amperage to the system. The electronic speed control would dictate how much power should be given to the motor depending on power output desired. The module and the electronic speed control can be the same device if the device handles both (but it does not have to be the same device). Aside from the initial starting of this system, once the system is on, it does not use battery power to stay on, and only uses the energy from an alternator or alternators, which is continuous. The system stays running and producing energy for the duration of time where it is needed. To power off the system, an electronic switch would be used which can be directed by the module to power it on or off. This switch would be located on the power wire to the electric motor or motors that are spinning alternators. This switch is powered on, once the system is started and switched off when it needs to be powered off. This system may have more than one motor with multiple alternators and/or have additional motors without alternators. The number of motors and alternators used depends on what the system is being built for (its application).

2. The electric power system of claim 1: The number of alternators and motors changes depending on the application. The AC or DC alternators and motors will vary in size depending on application. AC and DC alternators will vary in voltage and amperage specs depending on application. It may be one but will usually be 2 or more alternators being used per application/device. This is not limited to these numbers. For example, a jet may have 96 alternators and multiple electric motors. An electric motor for multiple alternators (which may be more than one motor) and electric motors for propulsion. It all depends on how much voltage/amperage is required for the electric motor or motors of a particular application. Electric motors with more than one rotor and/or more than one stator may be used.

3. The electric power system of claim 1: Size of alternators, motors and batteries will vary depending on application. Voltage regulation devices/Voltage limiting devices would also be altered depending on application to allow higher potential of alternator energy in volts and amperage. Special wiring/devices for such voltages/amperages would be used. Alternators with more than 1 rotor and more than 1 stator may be used. In some applications an electric motor may have an extended shaft on both sides of the motor. Heat sinks, heat fins, heat shields and/or similar devices would be used to assist with parts that get hot anywhere in the system.

4. The electric power system of claim 1: On some applications energy requirements may need to be higher, so that a device that steps up voltage or amperage or does both would also be used to reach certain voltage and amperage levels. An example would be placing a transformer/boost converter between the power source and the motor or motors. There may be more than one transformer/boost converter used but it depends on the application. Also, devices that change DC to AC power or AC to DC power could be used in the system depending on application. An example would be use of an inverter/rectifier between the power source and motor or motors. Similar devices that perform similar tasks to the ones described in this claim can be used and will vary depending on application. If needed devices that step down voltage and amperage levels may be used as well.

5. The electric power system in claim 1: one of the following would be used to get the alternators rotating with the main electric motor: pulleys and belts would be used, gears may be used, or sprockets with chains may be used, or some type of compressor, turbo, turbine and/or twin turbine with linked piping to each (alternator (each with a compressor wheel and housing)). The compressed air system pushes compressed air with initial air flow starting at the compressor connected to the electric motor shaft. The compressed air would spin the alternators. An air compressor may also feed a turbo or twin turbo to increase the air flow through the system. Anything that is similar to these designs that functions the same way for the same reason may be used.

6. The electric power system in claim 5: In a power system that uses compressors, turbines, turbos, or a combination, the last pipe in the sequence would have excess airflow which can be routed to specific parts of the system that usually get hot. The last pipe in the sequence would have a series of air lines that get air flow from this pipe. The last pipe in the sequence would be connected to a honeycomb like device that can connect multiple air lines. The air lines would branch out through the entire power system. The air flow line system could be used as a cooling method for electrical components that get hot. Each line would have a nozzle that produces an air jet stream aimed at a specific electrical component. More than 1 nozzle can be used on each line and can be pointed in any direction on any of these lines. The pipes/lines/hoses may be of any material suited for the application.

7. The electric power system in claim 1: Some versions of this power system do require a battery, similar apparatus or any liquid, gaseous, solid object/thing that provides enough energy to the starter motor or motor.

8. The electric power system in claim 1: may not have to use a starter motor to get started if the resistance of the system is minimal enough to turn or push by hand or foot. Any device that you need to use a hand or foot to start may be used. Instead of using a starter, the system would instead use a crank/lever or similar device or similar mechanical system. This system has gearing and/or a flywheel that makes it easier to start the electric power system by hand or foot. What would be used to start the power system depends on application. This optional starting system uses gearing that turns the electric motor easily and quickly. A pull start, kick start, a type of start that uses a lever, type of start that uses a crank, leg push start or similar design may be used. Any similar or combination of methods to start the system without use of battery power may be used but it all depends on application.

9. The electric power system in claim 1: uses an “MSCU” or equivalent module in order to operate and function as designed. The MSCU is short for a motor speed control unit. It distributes electrical energy throughout the system and controls functions of the system described. The main MSCU contains a hard drive. The MSCU also monitors voltage output from alternators, monitors total voltage produced, sets idle speed, sets RPM range, allows Addition or limitation of voltage and amperage sent to each electric motor, monitors temp in certain areas of system, and has other functions. The electric power system MAIN MSCU would have the power systems software installed in its hard drive. Software would be specific to each application. An application may use multiple MSCU's. An MSCU could be built into an alternator or motor. An MSCU could have an MSL built into it. On certain applications an MSCU may not be required. MSCU may use battery power temporarily if system is off. Once system is on, it uses alternator power. If a power system uses a manual device to start it, MSCU would begin operation once power is generated.

10. The electric power system in claim 1: uses an “MSL”. This is short for motor speed limiter and is a device that requests a load in this power system. The MSL can have a single preset or have the option to have many different load options depending on power requirements. Load options also depend on application. This device communicates to the MSCU. An MSL may be used or equivalent device. Some applications may have an MSL built into an MSCU. Some applications may only need to use an MSL. An MSL could be built into an alternator or motor.

11. The electric power system in claim 1: may use a Motornator in place of a motor. A Motornator is a motor and alternator single unit. Instead of having a motor and alternator as separate units, this unit would be a motor combined with an alternator under one casing (or connected casings). Any alterations described in any claims listed in this document may be used with this. More than 1 motor and/or more than 1 alternator may be used under one casing. More than 1 rotor and or more than 1 stator may be used on either a motor or alternator. This MotorNator would be a single unit and can take the place of motor 1. The purpose of this would be to simply add more electrical energy to the power system. The Motornator may be used without additional alternators surrounding the casing if it supplies sufficient power by itself. Inside each casing, the electric motor and alternator would be separate but wired together to work as one. They may use a plate or a separator to separate each component under the casing. A motornator may be wired in parallel, series or other ways.

12. The power system in claim 6: may use the following one or more of: blow off valve, wastegate and a device similar to a throttle body to regulate boost pressure from the compressor on models that have air cooled systems. Similar parts may be used. These parts would be optional.

13. The electric power system and additions to claim 1: This patent for a power system, is for any device, vehicle, application or anything that needs electric energy in order to operate. It is also for the generation of electric energy in general. This power system can be engineered to create enough power to compete with current powerplant technology. It may also be used to charge a battery or charge batteries of any size. Any claims listed here can be used with one another to create a power system specific to an application.
